(19) United States
(12) Patent Application Publication
(10) Pub. No.: US 2026/0195952 A1
(43) Pub. Date: Jul. 9, 2026

(54) METHOD AND APPARATUS FOR 3D GAUSSIAN-BASED DYNAMIC SCENE REPRESENTATION USING MOTION DECOMPOSITION

(71) Applicant: Electronics and Telecommunications Research Institute, Daejeon (KR)

(72) Inventors: Sang Woon KWAK, Daejeon (KR); Joon Soo KIM, Daejeon (KR); Jun Young JEONG, Daejeon (KR); Ji Hyong OH, Seoul (KR)

(73) Assignee: Electronics and Telecommunications Research Institute, Daejeon (KR)

(21) Appl. No.: 19/442,364

(22) Filed: Jan. 7, 2026

(30) Foreign Application Priority Data
Jan. 7, 2025 (KR) 10-2025-0002494
Dec. 29, 2025 (KR) 10-2025-0213194

(51) Int. Cl. G06T 13/20; G06T 17/00

(52) U.S. Cl. CPC G06T 13/20; G06T 17/00

(57) ABSTRACT

A method for representing a dynamic scene based on 3D Gaussian, the method comprises: receiving a monocular video or a multi-view video; mapping an anchor point to a voxel in a voxel grid for the monocular video or the multi-view video; deriving a transformed anchor point by performing a first transformation on an attribute of the anchor point; reconstructing a neural Gaussian from the transformed anchor point; deriving a neural Gaussian for a target timestamp by performing a second transformation on an attribute of the reconstructed neural Gaussian, wherein a global motion of the dynamic scene is represented through the first transformation, and a local motion of the dynamic scene is represented through the second transformation.

### CROSS-REFERENCE TO RELATED APPLICATIONS

This application claims the benefit of earlier filing date and right of priority to Korean Application No. 10-2025-0002494, filed on Jan. 7, 2025, Korean Application No. 10-2025-0213194, filed on Dec. 29, 2025, the contents of which are all hereby incorporated by reference herein in their entirety.

### TECHNICAL FIELD

The present disclosure relates to a method for learning and representing a scene using a three-dimensional Gaussian and an apparatus for performing the same.

### BACKGROUND

3D Gaussian Splatting (3DGS) is a 3D Gaussian-based scene representation technology that models the 3D space to be represented as point cloud data with attribute information in the form of a 3D Gaussian distribution, and may optimize each Gaussian attribute through learning through rendering loss. 3DGS technology is receiving significant attention for its high scene reconstruction quality and for effectively resolving rendering speed issues seen in general scene representation technologies through a GPU-friendly tile-based rendering technique.

The attribute information of each Gaussian in a 3DGS may be represented as floating-point real-valued data. Depending on the scene characteristics and optimization level, typically tens to millions of 3D Gaussians may be constructed to represent a single stationary 3D scene, and the stored model size may reach millions of megabytes.

### SUMMARY

The object of the present disclosure is to provide a method for representing 3D Gaussian-based scenes using sparse voxel grids.

The object of the present disclosure is to provide a method for representing 3D Gaussian-based scenes through stepwise deformation using motion decomposition.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for representing a dynamic scene based on 3D Gaussian, the method comprising: receiving a monocular video or a multi-view video; mapping an anchor point to a voxel in a voxel grid for the monocular video or the multi-view video; deriving a transformed anchor point by performing a first transformation on an attribute of the anchor point; reconstructing a neural Gaussian from the transformed anchor point; deriving a neural Gaussian for a target timestamp by performing a second transformation on an attribute of the reconstructed neural Gaussian, wherein a global motion of the dynamic scene is represented through the first transformation, and a local motion of the dynamic scene is represented through the second transformation.

In the method for representing a dynamic scene based on 3D Gaussian according to the present disclosure, the attribute of the anchor point includes at least one of position, offset, scale, local context feature, global dynamics, and local dynamics.

In the method for representing a dynamic scene based on 3D Gaussian according to the present disclosure, the transformed anchor point is derived by adding a transformation value to the attribute of the anchor point, and the transformation value is obtained by performing the first transformation on the attribute of the anchor point.

In the method for representing a dynamic scene based on 3D Gaussian according to the present disclosure, training is performed on global dynamics and local dynamics of the anchor point.

In the method for representing a dynamic scene based on 3D Gaussian according to the present disclosure, the trained global dynamics is masked to the deformation value of a position.

In the method for representing a dynamic scene based on 3D Gaussian according to the present disclosure, the trained local dynamics is multiplied by the transformation value of a local context feature.

In the method for representing a dynamic scene based on 3D Gaussian according to the present disclosure, the second transformation is performed using a hexplane and a multi-layer perceptron.

In the method for representing a dynamic scene based on 3D Gaussian according to the present disclosure, the second transformation is performed during a specific time interval, and the specific time interval is derived by dividing the entire frame equally.

In the method for representing a dynamic scene based on 3D Gaussian according to the present disclosure, the specific time interval is scene-adaptive adjusted, and the adjustment is performed based on a gradient.

In the method for representing a dynamic scene based on 3D Gaussian according to the present disclosure, the specific time interval is adjusted by a preset step size, and the adjustment is performed based on statistical characteristics of accumulated gradients for the attribute of the anchor point over a certain number of iterations.

In the method for representing a dynamic scene based on 3D Gaussian according to the present disclosure, for the time interval where the accumulated gradient is relatively large, a length of the time interval is reduced.

In accordance with an aspect of the present disclosure, the above and other objects can be accomplished by the provision of an apparatus for representing a dynamic scene based on 3D Gaussian, the apparatus comprising: one or more transceivers; one or more memories; and one or more processors, wherein the one or more processors being configured to: receive a monocular or a multi-view video, map an anchor point to a voxel in a voxel grid for the monocular or the multi-view video, derive a transformed anchor point by performing a first transformation on an attribute of the anchor point, reconstruct a neural Gaussian from the transformed anchor point, derive a neural Gaussian for a target timestamp by performing a second transformation on an attribute of the reconstructed neural Gaussian, wherein a global motion of the dynamic scene is represented through the first transformation, and a local motion of the dynamic scene is represented through the second transformation.

In the apparatus for representing a dynamic scene based on 3D Gaussian according to the present disclosure, the attribute of the anchor point includes at least one of position, offset, scale, local context feature, global dynamics, and local dynamics.

In the apparatus for representing a dynamic scene based on 3D Gaussian according to the present disclosure, the transformed anchor point is derived by adding a transformation value to the attribute of the anchor point, and the transformation value is obtained by performing a first transformation on the attributes of the anchor point.

In the apparatus for representing a dynamic scene based on 3D Gaussian according to the present disclosure, training is performed on global dynamics and local dynamics of the anchor point, the trained global dynamics is masked to the deformation value of a position, and the trained local dynamics is multiplied by the transformation value of a local context feature.

In the apparatus for representing a dynamic scene based on 3D Gaussian according to the present disclosure, the second transformation is performed using a hexplane and a multi-layer perceptron.

In the apparatus for representing a dynamic scene based on 3D Gaussian according to the present disclosure, the second transformation is performed during a specific time interval, the specific time interval is scene-adaptive adjusted, and the adjustment is performed based on a gradient.

In the apparatus for representing a dynamic scene based on 3D Gaussian according to the present disclosure, the specific time interval is adjusted by a preset step size, and the adjustment is performed based on statistical characteristics of accumulated gradients for the attribute of the anchor point over a certain number of iterations.

In the apparatus for representing a dynamic scene based on 3D Gaussian according to the present disclosure, for a time interval where the accumulated gradient is relatively large, a length of a time interval is reduced.

One or more non-transitory computer-readable medium storing one or more instructions, wherein the one or more instructions, when executed by one or more processors, are configured to control an apparatus for representing a dynamic scene based on 3D Gaussian to perform an operation, wherein the operation comprises: receiving a monocular or a multi-view video; mapping an anchor point to a voxel in a voxel grid for the monocular video or the multi-view video; deriving a transformed anchor point by performing a first transformation on an attribute of the anchor point; reconstructing a neural Gaussian from the transformed anchor point; deriving a neural Gaussian for a target timestamp by performing a second transformation on an attribute of the reconstructed neural Gaussian, wherein a global motion of the dynamic scene is represented through the first transformation, and a local motion of the dynamic scene is represented through the second transformation.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

FIG. 1 is a flowchart illustrating a method for representing dynamic scene based on 3D Gaussian the present disclosure.

FIG. 2 is a diagram illustrating a three-dimensional Gaussian transformation according to one embodiment of the present disclosure.

FIG. 3 is a diagram illustrating a time interval adjustment process according to one embodiment of the present disclosure.

FIG. 4 is a diagram illustrating a scene generated through three-dimensional Gaussian transformation according to one embodiment of the present disclosure.

FIG. 5 is a diagram illustrating an apparatus for representing dynamic scene based on 3D Gaussian the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

A hexplane may be a feature plane that receives center coordinates (x, y, z) of each Gaussian and a timestamp t as input, and outputs six features corresponding to xy, yz, xz, xt, yt, and zt.

A timestamp may represent a normalized frame index between 0 and 1.

A canonical space may refer to the space where initial Gaussians are located before being transformed to a specific time t.

A time interval may refer to a unit for representing or modeling the motion of Gaussians.

Anchor can be understood as being replaced by anchor point.

3D Gaussian-based scene representation technology (3D Gaussian Splatting, 3DGS) models the 3D space to be represented as point cloud data with attribute information in the form of a 3D Gaussian distribution and may optimize each Gaussian attribute through learning through rendering loss.

The attribute information of each Gaussian in 3DGS may include at least one of the following μ, s, q, c, and o.
μ∈R³: This may represent the mean value of a 3D Gaussian. This can determine the center coordinates of the 3D Gaussian.
S∈R³: This may represent the scale vector of a 3D Gaussian. This can determine the covariance matrix of the 3D Gaussian.
q∈R⁴: This may represent the rotation quaternion of a 3D Gaussian. This can determine the covariance matrix of the 3D Gaussian.
c∈R⁴⁸: This may mean the coefficients of the 4-dimensional spherical harmonic function, which is the attribute value corresponding to the color information of a 3D Gaussian.
o∈[0,1]: This may represent the opacity value of a 3D Gaussian. This may be used for alpha blending during rendering.

The attribute information of each Gaussian in a 3DGS may be represented as floating-point real-valued data. Depending on the scene characteristics and optimization level, typically tens to millions of 3D Gaussians may be constructed to represent a single stationary 3D scene, and the stored model size may reach millions of megabytes.

To reduce the high model capacity of 3DGS and improve efficiency, Gaussian splatting techniques based on sparse voxels (e.g., Scaffold-GS) have been proposed.

In a general sparse voxel-based Gaussian splatting model, the entire scene may be structured into a sparse voxel grid using the point cloud obtained through Structure from Motion (SfM). Each structured voxel may be mapped to an anchor point. The anchor point may have learnable offsets, scaling factors, local contexts, etc. In the rendering stage of the sparse voxel-based Gaussian splatting model, 3D Gaussians may be reconstructed by generating neighboring Gaussians based on the attribute values for anchor points included within the view frustum (a 3D frustum corresponding to the field of view of the rendering view). This is called a neural Gaussian. That is, there are L neural Gaussians at positions offset from the anchor point, and the attributes of the neural Gaussians are inferred by inferring them using a multi-layer perceptron with local context as input, thereby reconstructing the attributes required for rendering. Here, L may be an integer greater than or equal to 1.

Sparse voxel-based Gaussian splatting models can significantly reduce the model size by storing only the attributes corresponding to anchor points, rather than storing all the attributes of 3D Gaussians, which can range from tens to millions. Although additional computation is required for attribute inference, real-time rendering performance may be maintained by performing computations only in the area corresponding to the view frustum. However, general sparse voxel-based Gaussian splatting models, like 3DGS, have the limitation that they can only represent scenes for still images.

While 3DGS generally offers high scene representation quality and rendering performance, it is limited to static scenes. Various technologies are being explored to extend this framework to represent dynamic scenes, such as 4D Gaussian Splatting (4DGS).

In dynamic 3D Gaussian representation technology, a hexplane-based deformation technique may be used for dynamic scene expansion. A hexplane may refer to a feature plane that receives the center coordinates (x, y, z) of each Gaussian and a timestamp t as input, and outputs six features corresponding to xy, yz, xz, xt, yt, and zt. Here, the timestamp may represent a normalized frame index between 0 and 1.

Features acquired through the hexplane may be concatenated across multiple scales and then input to an MLP to be output as a deformation of the Gaussian attribute. By reflecting the deformation of the Gaussian attribute, the Gaussian at time t with the center position, rotation quaternion, and scale vector deformed. Consequently, a 3D Gaussian-based representation of dynamic scenes can be achieved. However, the general dynamic 3D Gaussian representation technology still has the problem of large model capacity because it still needs to store tens to millions of 3D Gaussians in canonical space. Furthermore, because the entire dynamic scene must be represented using a single deformation function, there is a limitation in that expressiveness decreases as the sequence length increases, particularly when motion becomes more complex.

Accordingly, the present disclosure provides a method for representing dynamic scenes by applying motion decomposition to a voxel-based structured representation. The method of the present disclosure improves the expressiveness for complex motion achieving a compact model capacity. Below, the method of the present disclosure will be examined in detail.

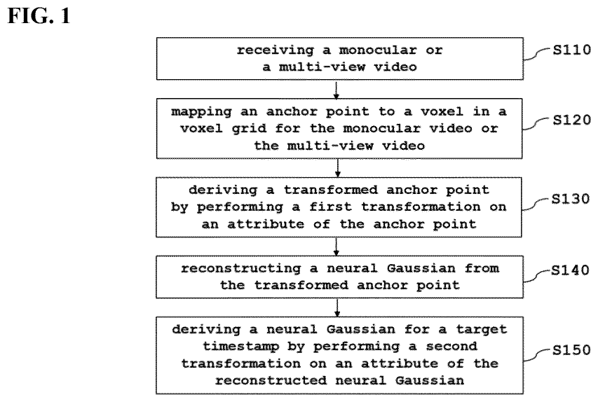

FIG. 1 is a flowchart illustrating a method for representing dynamic scene based on 3D Gaussian the present disclosure.

Referring to FIG. 1, a monocular video or a multi-view video is received S110.

Monocular video may refer to images or videos captured using a single camera. Multi-view video may refer to images or videos of a single subject captured from different positions (viewpoints) using multiple cameras. Monocular or multi-view videos may include camera parameter information. The input monocular videos or multi-view videos may be referred to as input videos.

Referring to FIG. 1, an anchor point is mapped to a voxel in a voxel grid for the monocular video or the multi-view video S120.

According to one embodiment of the present disclosure, a voxel grid can be constructed from an input video. The voxel grid may represent information about the entire dynamic scene and may also be referred to as a global canonical voxel grid. The voxel grid may be learned by observing the entire frame, and an anchor point may be mapped to each voxel. The anchor point may have at least one of the following attributes.
v∈R³: Position of anchor point
Oᵥ∈R^{L}: Learnable offset
sᵥ∈R¹: Learnable scale
fᵥ∈R^{k}: Local context feature
d_{G}∈R¹: Learnable global dynamics
d_{L}∈R¹: Learnable local dynamics

v may represent the center coordinate of the voxel as the location of the anchor point. v may include x-axis, y-axis, and z-axis coordinate values. Oᵥ and sᵥ are learnable offset and scale, respectively, which may indicate how far the L Gaussians generated from the anchor points are from v. fᵥ is a local context feature that may be used to reconstruct attributes other than the position of the neural Gaussian.

Meanwhile, transformation may be performed on the received monocular video or multi-view video. The transformation may be performed through one or more steps.

Referring to FIG. 1, a transformed anchor point is derived by performing a first transformation on an attribute of the anchor point S130.

According to one embodiment of the present disclosure, a first transformation may be performed on an anchor point. In this case, transformations may be performed on attributes such as local context features. Accordingly, it is possible to model the global motion of an anchor point that occurs over a specific time interval.

For example, the attributes of an anchor point may be transformed using a global hexplane and a multi-layer perceptron. In this case, the attributes of an anchor point may be encoded using the global hexplane and a multi-layer perceptron, and then decoded using a multi-head anchor decoder.

According to one embodiment of the present disclosure, the anchor point may have at least one of the following deformation values through the first deformation.
Δx,Δy,Δz
Δfᵥ
ΔOᵥ
Δsᵥ

In this case, the local context feature transformation value (Δfᵥ) may be obtained using the following mathematical equation 1.

$$Δ {f}_{v} = {φ}_{f} [ {F}_{G} ( {H}_{G} ( {x}_{v ,} {y}_{v} , {z}_{v} , {t}_{c} ) ] \qquad [ Mathematical equation 1 ]$$

Here, xᵥ, yᵥ, and zᵥ may represent the x-axis, y-axis, and z-axis coordinate values of the anchor point, respectively. t_{c} may represent canonical time. H_{G} may mean a global hexplane. F_{G} may represent a multi-layer perceptron. φ_{f} may represent a local context feature head used in a multi-head anchor decoder.

According to one embodiment of the present disclosure, the first transformation may be performed on a timestamp (t_{c}). This timestamp may be referred to as a canonical time, which serves as a reference time for calculating the transformation of the anchor point. The canonical time may serve as a starting boundary as the lowest timestamp of a time interval. The canonical time may be at least one of a plurality of timestamps included in a time interval list.

For example, the above time interval list may be structured as in the following mathematical equation 2.

$${T}_{c} = [ {t}_{1} , {t}_{2 ,} {t}_{3 , … ,} {t}_{I - 1} ] \qquad [ Mathematical equation 2 ]$$

The entire N frames may be divided into I time intervals, where I can be an integer greater than 1 and less than N. Accordingly, the list of time intervals can contain timestamps from t₁ to tᵢ₋₁. If the entire frame is divided equally, the same time intervals may be applied, allowing the same global motion to be applied.

According to one embodiment of the present disclosure, the motion characteristics of each anchor may be learned and stored through learnable dynamics of anchor points. Even in dynamic scenes, a significant portion of the scene may remain static. To prevent the representational capacity of the deformation function from being wasted in these areas, the motion characteristics of the corresponding anchor points may be learned as real-valued values.

Dynamics may include global dynamics and/or local dynamics. Motion characteristics of the entire voxel may be learned through global dynamics. Variational characteristics of local context features of anchor points may be learned through local dynamics. In this case, the learned global dynamics can be masked to the deformation values of the attributes. The learned local dynamics can be multiplied to the deformation values of the attributes.

For example, the masking value may be derived as in the following mathematical equation 3.

$$M ( {d}_{G} ) = sg ( I [ σ ( {d}_{G} ) > ϵ ] - σ ( {d}_{G} ) ) + σ ( {d}_{G} ) \qquad [ Mathematical equation 3 ]$$

Here, sg(⋅) may mean the stop gradient operator. I may mean an indicator, i.e., a guidance function. σ(⋅) may mean the sigmoid function. ϵ may mean a masking threshold.

M(d_{G}) may selectively distinguish between dynamic and static anchor points in complex dynamic scenes, thereby distinguishing between dynamic and static regions of the scene.

According to one embodiment of the present disclosure, learned dynamics may be incorporated into the transformed values of attributes. The attributes of the transformed anchor points may be derived as shown in the following mathematical equation 4.

$${x}_{v} ’ , {y}_{v} ’ , {z}_{v} ’ = ( {x}_{v} , {y}_{v} , {z}_{v} ) + M ( {d}_{G} ) \cdot ( Δ x , Δ y , Δ z ) \qquad [ Mathematical equation 4 ]$$

$${f}_{v}^{′} = {f}_{v} + Δ f \cdot σ ( {d}_{L} )$$

$${o}_{v}^{′} = {o}_{v} + Δ o \cdot σ ( {d}_{L} )$$

$${s}_{v}^{′} = {s}_{v} + Δ s \cdot σ ( {d}_{L} )$$

Referring to FIG. 1, a neural Gaussian is reconstructed from the transformed anchor point S140.

According to one embodiment of the present disclosure, K neural Gaussians may be reconstructed from deformed anchor points within a view frustum, where K may be an integer greater than or equal to 1.

For example, the opacity (α) set of the neural Gaussian may be reconstructed as shown in the following mathematical equation 5.

$${\{ {α}_{0} , … , {α}_{k - 1} \} = {F}_{α} ( \hat{f} ’}_{v} , {δ}_{{v}^{′} , cam} , {\vec{d}}_{{v}^{′} , cam} ) \qquad [ Mathematical equation 5 ]$$

Here, F_{α} may represent a multi-layer perceptron decoder. The final opacity value may be calculated using the features and view information input through the multi-layer perceptron decoder. \hat{f}′ᵥ may represent a feature bank constructed from the features of the deformed anchor point. δ_{v′,cam} may represent the relative distance from the viewpoint to the deformed anchor point. \vec{d}_{v′,cam} may represent the direction from the viewpoint to the deformed anchor point.

Referring to FIG. 1, a neural Gaussian for a target timestamp is derived by performing a second transformation on an attribute of the reconstructed neural Gaussian S150.

Once the global motion of the scene is modeled in S130, the remaining local motion may be modeled.

According to one embodiment of the present disclosure, a second transformation may be performed on the attributes of the reconstructed neural Gaussian. The transformation may be performed using a hexplane and a multi-layer perceptron on the attributes of the reconstructed neural Gaussian through neural Gaussian derivation.

According to one embodiment of the present disclosure, the second transformation may be performed over a specific time interval.

According to one embodiment of the present disclosure, a total of N frames may be divided into I time intervals, where I may be an integer greater than 1 and less than N. Accordingly, the second transformation may initially be performed over a uniform time interval.

Meanwhile, the time intervals may be adjustable variables. Specifically, specific time intervals may be adjusted scene-adaptive.

For example, the time interval may be adjusted scene-adaptive based on the gradient calculated during the learning process. Specifically, the gradient for the Gaussian attribute value may be summed for each time interval. Based on the statistical characteristics of the accumulated gradients for a predetermined number of iterations, the time interval may be adjusted by a preset step size (s_{TIA}).

For example, the time interval length may be reduced for the time interval where the accumulated gradient (the accumulated gradient amount) is relatively large. A large, accumulated gradient may indicate that a significant amount of change is required in that time interval, which in turn may indicate relatively greater representational capacity of the transformation function is required compared to other time intervals. By reducing the length of the time interval of the relevant section and redistributing it in a way that makes the required representational capacity for each section similar, it can help improve the representational capacity of the overall transformation function.

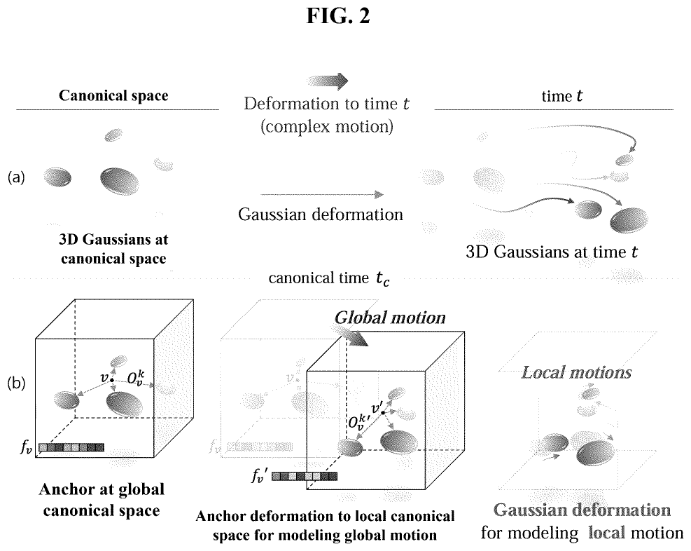

FIG. 2 is a diagram illustrating a three-dimensional Gaussian transformation according to one embodiment of the present disclosure.

Specifically, FIG. 2(a) is a diagram illustrating a general Gaussian transformation.

The left side of FIG. 2(a) shows 3D Gaussians in canonical space, and the right side of FIG. 2(a) shows 3D Gaussians at time t. This may be the result of a transformation performed on the 3D Gaussians in canonical space. According to the general Gaussian transformation, the motion of Gaussians may be expressed through a single transformation function. However, when expressing an entire dynamic scene with only a single transformation function, there is a problem that expressiveness decreases as the sequence length increases, particularly when motion becomes more complex.

Specifically, FIG. 2(b) is a diagram illustrating stepwise Gaussian transformation using motion decomposition.

On the left side of FIG. 2(b), anchor points are shown in the voxel grid.

The center of FIG. 2(b) illustrates an embodiment of performing a first transformation on the attributes of an anchor point. Referring to FIG. 2(b), an anchor point in a voxel grid may have attributes, including a position v, an offset Oᵥ, and/or a local context feature fᵥ. In this case, the transformed attributes may be obtained by transforming the attributes of the anchor point (e.g., local context, etc.). For example, a transformed position v′, a transformed offset O_{v′}, and/or a transformed local context feature f_{v′} may be obtained. The global motion of the anchor point that occurs during a specific time interval may be modeled through the first deformation.

The right side of FIG. 2(b) illustrates an example of performing a second transformation on the attributes of the reconstructed neural Gaussian. The local motion of the Gaussian may be modeled through the second transformation.

The stepwise Gaussian transformation using motion decomposition proposed in this disclosure may express not only global object-level motion but also local Gaussian-level motion. This allows for the expression of complex motions and enhances the expressiveness of scenes.

Attempting to model all the diverse dynamic motions of the real world with a single deformation function may result in poor expressiveness. The method of the present disclosure may enhance expressiveness for complex motions through stepwise deformation.

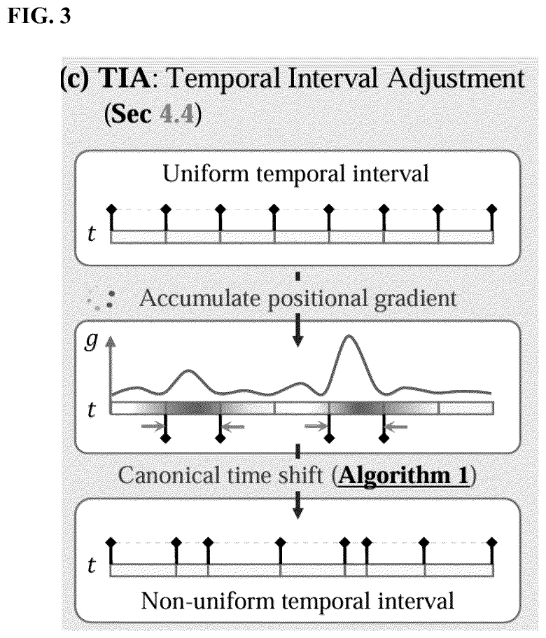

FIG. 3 is a diagram illustrating a time interval adjustment process according to one embodiment of the present disclosure.

According to one embodiment of the present disclosure, the entire frame may be divided into equal time intervals to adjust the time intervals. At the beginning of learning, the entire N frames may be divided into equal time intervals I, where I may be an integer greater than 1 and less than N.

Meanwhile, according to one embodiment of the present disclosure, the time interval may be adjusted scene-adaptive. This is because dividing the time interval unequally according to scene characteristics may help increase expressiveness.

For example, the time interval may be adjusted scene-adaptively based on the gradient calculated during the learning process. Specifically, the gradients for the Gaussian attribute value may be summed for each time interval. Based on the statistical characteristics of the accumulated gradients for a predetermined number of iterations, the time interval may be adjusted by a preset step size.

For example, the time interval length may be reduced for the time interval where the accumulated gradient is relatively large. A large, accumulated gradient may indicate that a significant amount of change is required in that time interval, which in turn may indicate a greater need for transformation function expressiveness compared to other intervals. By reducing the length of the time interval of the relevant section and redistributing it in a way that makes the required representational capacity for each section similar, it can help improve the representational capacity of the overall transformation function.

Table 1 below shows an algorithm for time interval adjustment according to one embodiment of the present disclosure.

TABLE 1
Algorithm 1

```
  1:  $procedure TIA ( {T}_{c} , {G}^{a c c} , {v}^{a c c} , {g}_{t}^{p o s} , {τ}_{TIA} , {s}_{TIA} )$
  2:  $if {T}_{f r o m}^{TIA} \leq iter \leq {T}_{u n t i l}^{TIA} then$
  3:  $Update {G}^{a c c} with {g}_{t}^{p o s}$
  4:  $if iter \% {T}_{p e r i o d}^{TIA} = 0 then$
  5:  $μ = {\sum }_{c = 0}^{ℓ - 1} ( {g}_{c}^{a c c} / {v}_{c}^{a c c} ) / ℓ$
  6:  $σ = \sqrt{{{\sum }_{c = 0}^{ℓ - 1} [ ( {g}_{c}^{a c c} / {v}_{c}^{a c c} ) - μ ]}^{2} / ℓ}$
  7: for j = 0 to [symbol]    − 1 do
  8:  $if {g}_{j}^{a c c} \geq μ + {τ}_{T I A} \cdot σ then$
  9: if j ≠ 0 and tⱼ ≤ tⱼ₊₁ − s_{TIA} then
10: tⱼ ← tⱼ + S_{TIA}
11: if j ≠ 0 and tⱼ ≤ tⱼ₊₁ − s_{TIA} then
12: tⱼ₊₁ ← tⱼ₊₁ − s_{TIA}
13: Init G^{acc}, v^{acc}, μ, σ
```

Referring to Table 1, the algorithm periodically evaluates the change in time intervals and adjusts them when the gap between time intervals becomes excessively wide or narrow.

Referring to Table 1, it may be verified whether the iterations are within a set range (See line 2 of Table 1).

Referring to Table 1, the current position value

$${g}_{t}^{pos}$$

may be used to update the accumulated gradient G^{acc}.

Referring to Table 1, adjustment of the time interval may only be performed when the iteration is a multiple of

$${T}_{period}^{TIA} .$$

In other words, the length of the time interval may only be adjusted at regular intervals.

Referring to Table 1, the accumulated gradient

$$( {g}_{c}^{acc} )$$

or each time interval may be normalized by the accumulated count

$$( {v}_{c}^{acc} ) ,$$

and then the (μ) and standard deviation (σ) may be calculated. Here, the mean may indicate the average of the gradients across all time intervals, and the standard deviation may indicate variability between time intervals.

Referring to Table 1, the following can be performed for each time interval index j:

For example, when the accumulated gradient of a specific time interval is greater than the mean by τ_{TIA}·σ, the time interval may be shrunk.

For example, when the distance between adjacent time intervals (tⱼ and tⱼ₊₁) is greater than s_{TIA}, the timestamp tⱼ may be moved backward by a preset step size (s_{TIA}), and the timestamp tⱼ₊₁ may be moved forward by a preset step size.

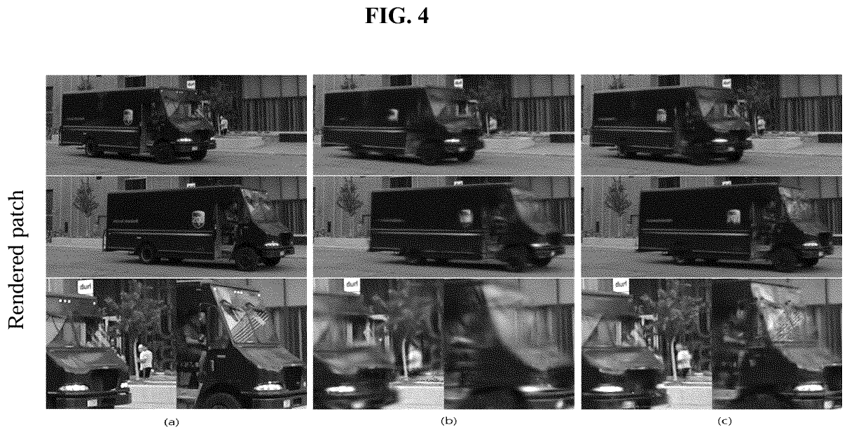

FIG. 4 is a diagram illustrating a scene generated through three-dimensional Gaussian transformation according to one embodiment of the present disclosure.

FIG. 4(a) illustrates the ground truth image.

FIG. 4(b) illustrates a scene generated without applying the method of the present disclosure, and FIG. 4(c) illustrates a scene generated with the method of the present disclosure.

The 3D Gaussians that constitute the 3D space may exhibit various motions, both large and small, during time t.

Many of the diverse dynamic motions in the real world may have complex forms that combine global and local motions of an object. Attempting to model all of the diverse dynamic motions in the real world with a single deformation function may result in poor expressiveness. The method of the present disclosure may enhance the expressiveness of complex motions through stepwise deformation.

As illustrated in FIG. 4(c), when the method of the present disclosure is applied, a scene with excellent quality in quantitative/qualitative image quality performance may be obtained even through a model with low capacity.

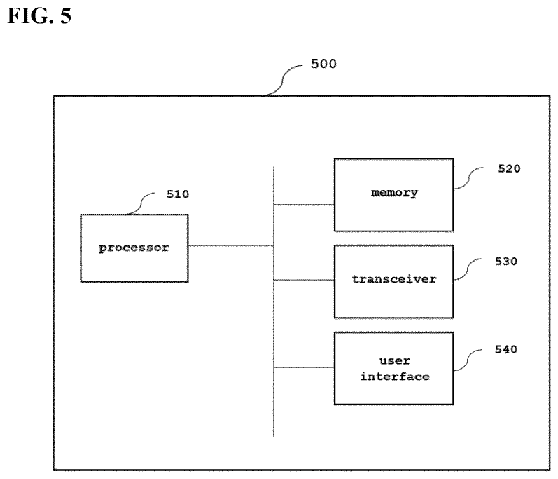

FIG. 5 is a diagram illustrating an apparatus for representing dynamic scene based on 3D Gaussian the present disclosure.

The apparatus 500 may include one or more processors 510, one or more memories 520, one or more transceivers 530, one or more user interfaces 540, etc. The memory 520 may be included in the processor 510 or may be configured separately. The memory 520 may store instructions that cause the apparatus 500 to perform operations when executed by the processor 510. The transceiver 530 may transmit and/or receive signals, data, etc. that the apparatus 500 exchanges with other entities. The user interface 540 may receive an input of the user for the apparatus 500 or provide an output of the apparatus 500 to the user. Among the components of the apparatus 500, components other than the processor 510 and the memory 520 may not be included in some cases, and other components not shown in FIG. 5 may be included in the apparatus 500.

The processor 510 may be configured to cause the apparatus 500 to perform operations of the device according to various examples of the present disclosure. Although not illustrated in FIG. 5, the processor 510 may be configured as a set of modules each performing a function. The modules may be configured in the form of hardware and/or software.

The processor 510 of the apparatus 500 can generally support/perform operations that are configured to receive a monocular video or a multi-view video, map an anchor point to a voxel in a voxel grid for the monocular video or the multi-view video; deriving a transformed anchor point by performing a first transformation on an attribute of the anchor point, reconstruct a neural Gaussian from the transformed anchor point, derive a neural Gaussian for a target timestamp by performing a second transformation on an attribute of the reconstructed neural Gaussian.

Here, a global motion of the dynamic scene is represented through the first transformation, and a local motion of the dynamic scene is represented through the second transformation.

The transceiver (530) of the device (500) may be configured to transmit the monocular video or the multi-view video.

In this regard, a detailed explanation has been provided with reference to FIG. 1, and a detailed explanation will be omitted here to avoid redundant explanation.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for representing a dynamic scene based on 3D Gaussian, comprising:
receiving a monocular video or a multi-view video;
mapping an anchor point to a voxel in a voxel grid for the monocular video or the multi-view video;
deriving a transformed anchor point by performing a first transformation on an attribute of the anchor point;
reconstructing a neural Gaussian from the transformed anchor point;
deriving a neural Gaussian for a target timestamp by performing a second transformation on an attribute of the reconstructed neural Gaussian,
wherein a global motion of the dynamic scene is represented through the first transformation, and a local motion of the dynamic scene is represented through the second transformation.

2. The method of claim 1, wherein the attribute of the anchor point includes at least one of position, offset, scale, local context feature, global dynamics, and local dynamics.

3. The method of claim 1, wherein the transformed anchor point is derived by adding a transformation value to the attribute of the anchor point, wherein the transformation value is obtained by performing the first transformation on the attribute of the anchor point.

4. The method of claim 1, wherein training is performed on global dynamics and local dynamics of the anchor point.

5. The method of claim 4, wherein the trained global dynamics is masked to the deformation value of a position.

6. The method of claim 4, the trained local dynamics is multiplied by the transformation value of a local context feature.

7. The method of claim 1, wherein the second transformation is performed using a hexplane and a multi-layer perceptron.

8. The method of claim 1, wherein the second transformation is performed during a specific time interval, and
wherein the specific time interval is derived by dividing the entire frame equally.

9. The method of claim 8, wherein the specific time interval is scene-adaptive adjusted, and
wherein the adjustment is performed based on a gradient.

10. The method of claim 9, wherein the specific time interval is adjusted by a preset step size, and
wherein the adjustment is performed based on statistical characteristics of accumulated gradients for the attribute of the anchor point over a certain number of iterations.

11. The method of claim 10, wherein for the time interval where the accumulated gradient is relatively large, a length of the time interval is reduced.

12. An apparatus for representing a dynamic scene based on 3D Gaussian, comprising:
one or more transceivers;
one or more memories;
and one or more processors,
wherein the one or more processors being configured to:
receive a monocular video or a multi-view video,
map an anchor point to a voxel in a voxel grid for the monocular video or the multi-view video;
derive a transformed anchor point by performing a first transformation on an attribute of the anchor point,
reconstruct a neural Gaussian from the transformed anchor point,
derive a neural Gaussian for a target timestamp by performing a second transformation on an attribute of the reconstructed neural Gaussian,
wherein a global motion of the dynamic scene is represented through the first transformation, and a local motion of the dynamic scene is represented through the second transformation.

13. The apparatus of claim 12, wherein the attribute of the anchor point includes at least one of position, offset, scale, local context feature, global dynamics, and local dynamics.

14. The apparatus of claim 12, wherein the transformed anchor point is derived by adding a transformation value to the attribute of the anchor point, and
wherein the transformation value is obtained by performing a first transformation on the attributes of the anchor point.

15. The apparatus of claim 12, wherein training is performed on global dynamics and local dynamics of the anchor point,
wherein the trained global dynamics is masked to the deformation value of a position, and
wherein the trained local dynamics is multiplied by the transformation value of a local context feature.

16. The apparatus of claim 12, wherein the second transformation is performed using a hexplane and a multi-layer perceptron.

17. The apparatus of claim 12, wherein the second transformation is performed during a specific time interval,
wherein the specific time interval is scene-adaptive adjusted, and
wherein the adjustment is performed based on a gradient.

18. The apparatus of claim 17, wherein the specific time interval is adjusted by a preset step size, and
wherein the adjustment is performed based on statistical characteristics of accumulated gradients for the attribute of the anchor point over a certain number of iterations.

19. The method of claim 18, wherein for a time interval where the accumulated gradient is relatively large, a length of a time interval is reduced.

20. A non-transitory computer-readable medium storing one or more instructions, wherein the one or more instructions, when executed by one or more processors, are configured to control an apparatus for representing a dynamic scene based on 3D Gaussian to perform an operation, comprising:
receiving a monocular video or a multi-view video;
mapping an anchor point to a voxel in a voxel grid for the monocular video or the multi-view video;
deriving a transformed anchor point by performing a first transformation on an attribute of the anchor point;
reconstructing a neural Gaussian from the transformed anchor point;
deriving a neural Gaussian for a target timestamp by performing a second transformation on an attribute of the reconstructed neural Gaussian,
wherein a global motion of the dynamic scene is represented through the first transformation, and a local motion of the dynamic scene is represented through the second transformation.
